(19) United States
(12) Patent Application Publication
(10) Pub. No.: US 2011/0113672 A1
(43) Pub. Date: May 19, 2011

(54) Remote controlled decoy

(76) Inventor: Larry Holmberg, Gully, MN (US)

(21) Appl. No.: 12/592,126

(22) Filed: Nov. 19, 2009

(51) Int. Cl. A01M 31/06

(52) U.S. Cl. 43/2; 43/3

(57) ABSTRACT

A remote controlled decoy for hunting includes a ground engaging element, a chassis, a motor, a video recorder, a game caller, and an animal shell. To move the decoy with respect to the ground, the motor and ground engaging elements are actuated via the remote control. To record images from the decoy, the video recorder is actuated via the remote control. To produce audio, the game caller is actuated via the remote control.

### BACKGROUND

The present invention relates generally to a decoy for hunting game. More particularly, the present invention relates to a remote controlled decoy resembling an animal.

Several types of hunting decoys have been proposed in the past. Early hunting decoys resembled wildfowl and were supported by stakes driven into the ground. Some of these staked decoys included one or more pivot mechanisms for allowing pivotal movement of the decoy. More recently, floating decoys have been proposed for use on water and wheeled decoys have been proposed for use on land.

### SUMMARY

One embodiment of the present invention is a remote controlled decoy for hunting. The decoy includes a ground engaging element, a chassis, a motor, a video recorder, a game caller, and an animal shell. The chassis is attached to the ground engaging element and the motor is attached to the chassis for driving the ground engaging element. The video recorder is mounted above the chassis for recording images, and the game caller is mounted above the chassis for producing audio. The animal shell is removably attachable around the game caller and video recorder.

Another embodiment of the present invention is a remote controlled decoy including an animal shell and a video recorder located within the animal shell. The animal shell has an opening and the video recorder has a lens positioned with respect to the opening for unobstructed recording of images.

Another embodiment of the present invention is a method for attracting game using a remote controlled decoy. The method includes actuating a video recorder on the decoy via the remote control, such that the decoy records images. The method also includes actuating ground engaging elements on the decoy via the remote control, such that the decoy moves with respect to the ground.

### BRIEF DESCRIPTION OF THE DRAWINGS

FIG. 1 is a perspective view of a hunter using a remote controlled decoy resembling a turkey in accordance with the present invention.

FIG. 2 is a perspective view of the remote controlled turkey decoy from FIG. 1.

FIG. 3 is an exploded perspective view of the remote controlled turkey decoy from FIG. 2.

FIG. 4 is a side view of the remote controlled turkey decoy from FIG. 3.

FIG. 5 is a front view of the remote controlled turkey decoy from FIG. 4.

FIG. 6 is a side view of another embodiment of a remote controlled decoy resembling a duck.

FIG. 7 is a front view of the remote controlled duck decoy from FIG. 6.

FIG. 8 is a side view of another embodiment of a remote controlled decoy resembling a cyote.

FIG. 9 is a front view of the remote controlled cyote decoy from FIG. 8.

FIG. 10 is a side view of another embodiment of a remote controlled decoy resembling a turkey.

FIG. 11 is a front view of the remote controlled turkey decoy from FIG. 10.

### DETAILED DESCRIPTION

The present invention relates to a remote controlled decoy for hunting and methods of using such a decoy to attract game. The remote controlled decoy may resemble any number of animals such as, but not limited to, a turkey, a duck or a cyote. The decoy is operated via a remote control and is capable of producing both movement and audio to increase realism. The decoy is also outfitted with a video camera for capturing images. The details and advantages of the present invention are described below with reference to specific embodiments illustrated in the Figures.

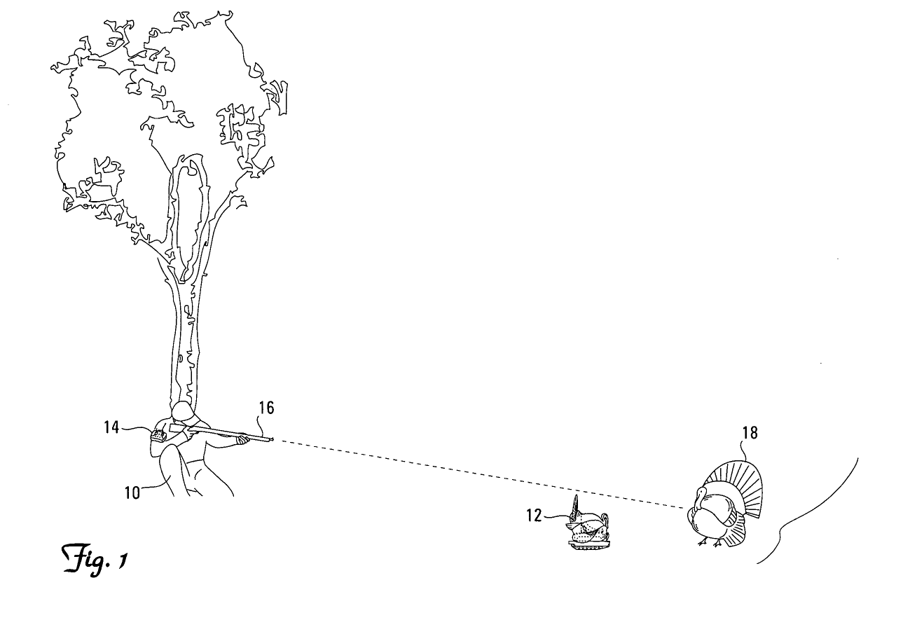

FIG. 1 is a perspective view of a hunter 10 using remote controlled turkey decoy 12 in accordance with the present invention. Depicted in FIG. 1 are hunter 10, turkey decoy 12, remote control 14, weapon 16, and wild game 18. In FIG. 1, remote control 14 is fastened around an arm of hunter 10, although remote control 14 could alternatively be fastened around a different limb such as leg of hunter 10, held in hand of hunter 10, or placed on the ground near hunter 10. As shown, hunter 10 sits near a tree and uses remote control 14 to operate turkey decoy 12. In response to commands from remote control 14, turkey decoy 12 moves, produces audio, and/or records images. Hunter's 10 operation of turkey decoy 12 lures wild game 18, such as a live turkey, within range of weapon 16.

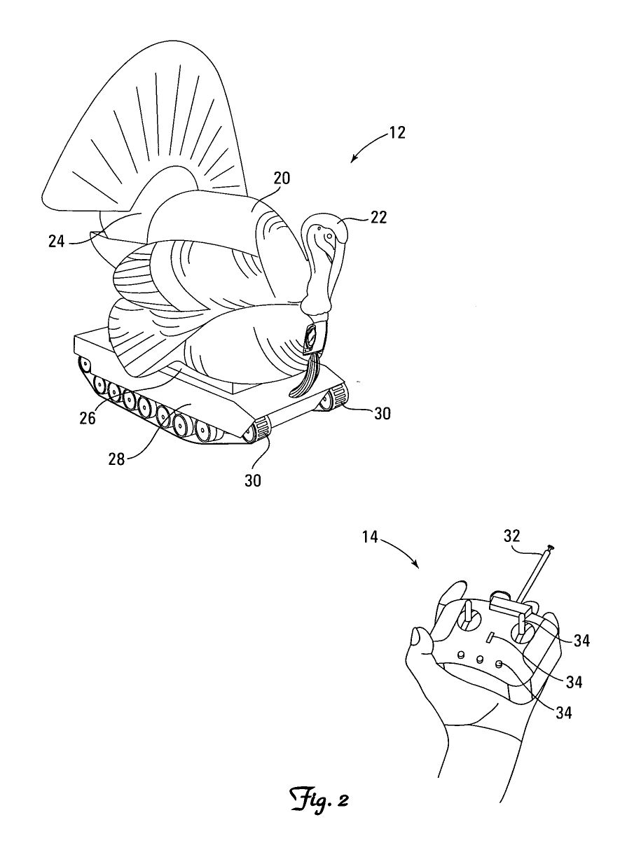

FIG. 2 is an enlarged perspective view of turkey decoy 12 from FIG. 1. Depicted in FIG. 2 are turkey decoy 12 and remote control 14. Turkey decoy 12 includes animal shell 20 having head portion 22 and tail portion 24, as well as base 26, chassis 28, and tracks 30. Remote control 14 includes antenna 32 and a plurality of actuators 34. Actuators 34 of remote control 14 operate the functional aspects of turkey decoy 12.

Animal shell 20 is hollow and can resemble any number of animals. In this particular embodiment, animal shell 20 is formed from a polymer and represents a male turkey (“gobbler” or “tom”). Animal shell 20 can be rigid or flexible, painted or unpainted, adorned or unadorned. There are a variety of commercially available animal shells 20 appropriate for use with decoy 12. Animal shell 20 has head portion 22 located at a first, forward end of the body, and tail portion 24 located at second, rearward end of the body. A bottom portion of animal shell 20 is releasably secured or attached around base 26 with any suitable means for temporarily fastening animal shell 20 to base 26. Base 26 is mounted on top of chassis 28 such that chassis 28 carries base 26 and attached animal shell 20. More specifically, a bottom surface of base 26 is attached to a top surface of chassis 28. Attached to each side of an under portion of chassis 28 are tracks 30. Tracks 30 are continuous and rugged means for engaging the ground beneath decoy 12 without becoming stuck, although wheels and other suitable means for engaging the ground are equally possible. Remote control 14 has antenna 32 extending from one side, and a plurality of actuators 34 (e.g. buttons, joysticks, switches) for remotely controlling the functional aspects of turkey decoy 12.

Animal shell 20 can resemble any animal useful as a decoy for hunting and is known in the art as a “turkey skin”. Head portion 22 carries a head of the turkey and tail portion 24 carries a tail of the turkey. Animal shell 20 is hollow and attached around base 26 to obscure the electrical components of decoy 12 from sight, as well as protect the electrical components from weather. Chassis 28 and tracks 30 provide support and means for providing linear locomotion to turkey decoy 12, respectively. Actuators 24 of remote control 14 correspond to functions of turkey decoy 12. Toggling of actuators 34 transmits signals out of antenna 32, for receipt by electrical components of turkey decoy 12 located beneath animal shell 20.

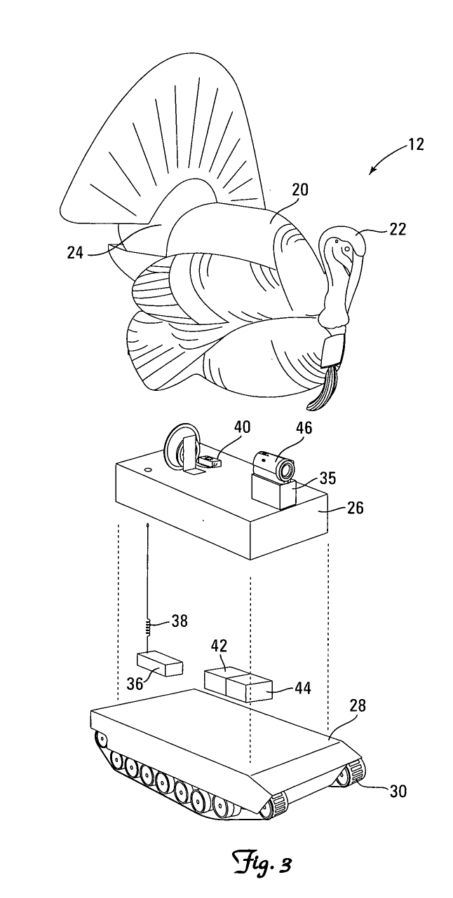

FIG. 3 is an exploded perspective view of turkey decoy 12 from FIG. 2. Visible in FIG. 3 are turkey decoy 12, animal shell 20, head portion 22, tail portion 24, base 26, chassis 28, tracks 30, stand 35, receiver 36, antenna 38, game caller 40, motor 42, battery 44, and video recorder 46. Animal shell 20 is exploded upwardly to expose the electrical components of turkey decoy 12 mounted to base 26 and chassis 28.

The electrical components of turkey decoy 12 (receiver 36, antenna 38, game caller 40, motor 42, battery 44, and video recorder 46) are mounted to either base 26 or chassis 28. Centered at the front end of base 26 is an upwardly extending stand 35. In the depicted embodiment, some of the electrical components are mounted to chassis 28, and others are mounted to base 26 (including stand 35). Mounted to chassis 28 in the following order (listed rear to front) are: receiver 36 having antenna 38, motor 42, and battery 44. Mounted to base 26/stand 35 in the following order (listed rear to front) are: game caller 40 and video recorder 46, although other mounting configurations and orders for electrical components are equally possible. In FIG. 3, each electrical component has a bottom surface removably mounted to a top surface of either base 26 (including stand 35) or chassis 28. Antenna 38 extends vertically upwards from a rear end of receiver 36. Battery 44 provides electrical energy to power receiver 36, game caller 40, motor 42, and video camera 46.

Antenna 38 receives signals from actuators 34 transmitted through antenna 32 of remote control 14 (depicted in FIG. 2). Receiver 36 then interprets and executes the remote commands received by antenna 38. Thus, actuators 34 are capable of remotely operating game caller 40 with an audio command, motor 42/tracks 30 with a move command, and video camera 46 with a record command. Actuation of game caller 40 produces audio, such as mating calls, which are matched to the animal represented by animal shell 20. In this particular embodiment, switching game caller 40 “on” produces a turkey gobble because animal shell 20 resembles a turkey. Game caller 40 can have a variety of audio options. Battery 44 stores power for operating the electrical components and tracks 30. Motor 42 converts the power stored in battery 44 to a form usable by tracks 30. Switching motor 42 “on” drives tracks 30 in continuous loops. Tracks 30 engage the ground beneath turkey decoy 12 thereby imparting movement to turkey decoy 12. Tracks 30 can provide more than mere linear locomotion motion and include options such as turning and reverse. Video recorder 46 is capable of recording both still and moving images, as well as recording audio through a built-in microphone. Switching video recorder 46 “on” causes video recorder 46 to capture either still or moving images and may also record audio in conjunction with the captured images. Receiver 36 allows for the functional aspects of turkey decoy 12 (game caller 40, motor 42/tracks 30, and video recorder 46) to be operated remotely.

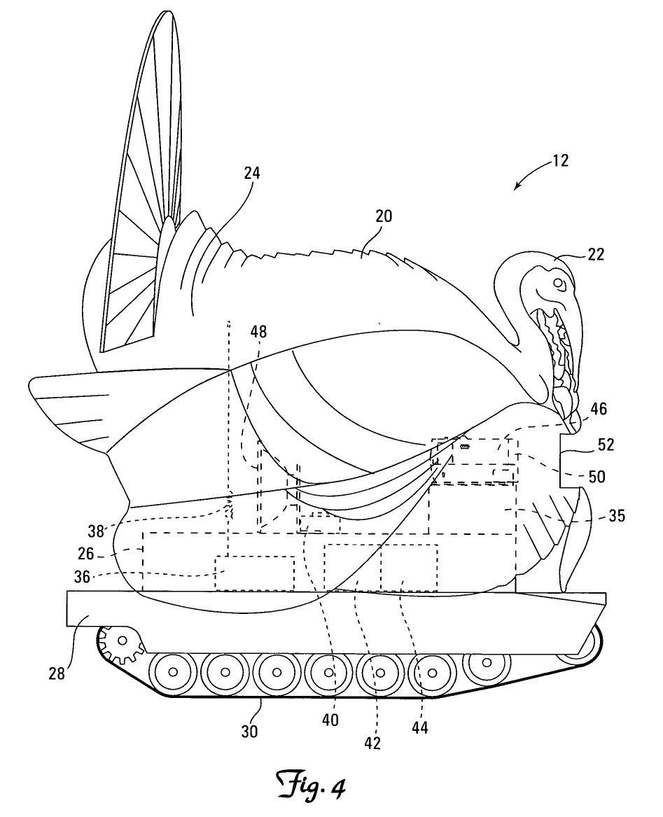

FIG. 4 is a side view of turkey decoy 12 from FIG. 3. Visible in FIG. 4 are turkey decoy 12, animal shell 20, head portion 22, tail portion 24, chassis 28, and tracks 30. Also depicted are the parts of turkey decoy 12 located beneath animal shell 20 (shown in phantom lines): base 26 including stand 35, receiver 36, antenna 38, game caller 40, motor 42, battery 44, and video recorder 46. Game caller 40 includes speaker 48, video recorder 46 includes lens 50, and head portion 22 of animal shell 20 includes opening 52. FIG. 4 demonstrates the spatial relationship between the parts of turkey decoy 12.

Tracks 30 are the portion of turkey decoy 12 nearest to the ground. Tracks 30 can be replaced with any suitable means for engaging the ground, such as wheels. Tracks 30 are mounted beneath, and/or attached to an underside of chassis 28. Attached to a top of chassis, or alternatively mounted within chassis 28, are receiver 36, motor 42, and battery 44. Covering receiver 36, motor 42 and battery 44, is base 26. Extending upwardly from a top of receiver 36 and through a rear hole in base 26 into tail portion 24 of animal shell 20 is antenna 38. Base 26 can be a hollow box-type structure placed around receiver 36, motor 42, and battery 44. Projecting upwardly from a front end of base 26 is stand 35. Base 26 and stand 35 are formed from a material with enough rigidity to support the weight of game caller 40 and video recorder 46. Game caller 40 and video recorder 46 are mounted above chassis 28 onto base 26 and stand 35, respectively.

Game caller 40 includes speaker 48 for projecting audio signals. Speaker 48 is located near, and facing, the rear of base 26. Game caller 40 and speaker 48 are located beneath, and generally surrounded by, tail portion 24 of animal shell 20. Video recorder 46 includes lens 50 for capturing images. Lens is located near, and facing, the front of base 26. Video camera 46 and lens 50 are located beneath, and generally surrounded by, head portion 22 of animal shell 20. Video recorder 46 and accompanying lens 50 can be raised off the top surface of base 26 by upwardly extending stand 35. Stand 35 has a height that aligns a top surface of stand 35 (and therefore a bottom surface of video recorder 46), with a bottom edge of opening 52. In the depicted embodiment, opening 52 is located in an approximate middle of head portion 22. When video camera 46 is mounted to the top surface of stand 35, lens 50 gains an unobstructed view out of animal shell 20 through opening 52.

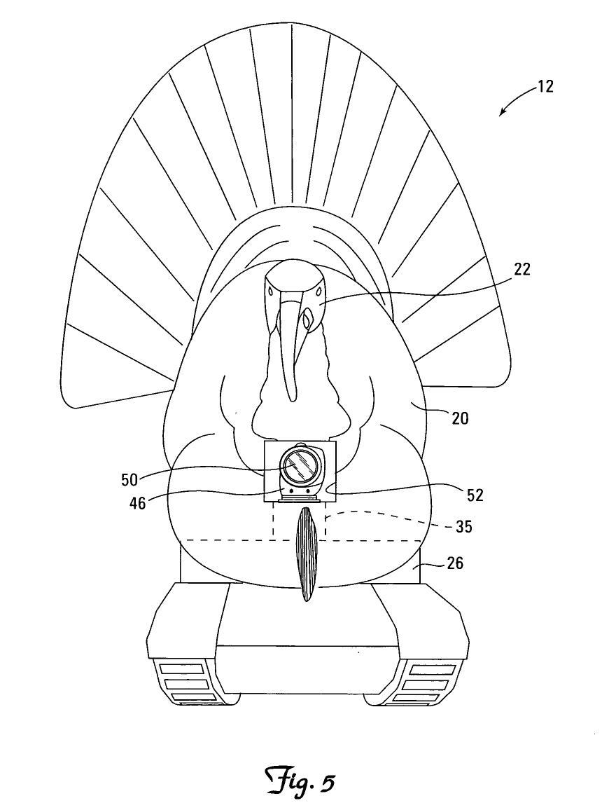

FIG. 5 is a front view of remote controlled turkey decoy 12 from FIG. 4. Visible in FIG. 5 are turkey decoy 12, animal shell 20, head portion 22, base 26, stand 35, video recorder 46, lens 50, and opening 52. Opening 52 in head portion 22 of animal shell 20 provides an unobstructed forward view for lens 50 of camera 46.

Opening 52 is centrally located in the front or head portion 22 of animal shell 20. In the depicted embodiment, opening 52 is a cut out square, although circular and other shaped-openings are equally possible. Opening 52 is preferably larger than lens 50 of video camera 46, so that lens 50 can capture an unobstructed view of action occurring in front of decoy 12. Video camera 46 is positioned so that lens 50 faces forward and is approximately centered with opening 52. Depending on the configuration of animal shell 20, stand 35 can be used in conjunction with base 26 to properly position lens 50 within opening 52. Stand 35 raises video camera 46 up off of base 26 so that a top surface of stand 35 and a bottom edge of video camera 46 are aligned with a bottom edge of opening 52. The above description has focused on one embodiment of remote controlled decoy 12 resembling a male turkey, but the invention is not so limited.

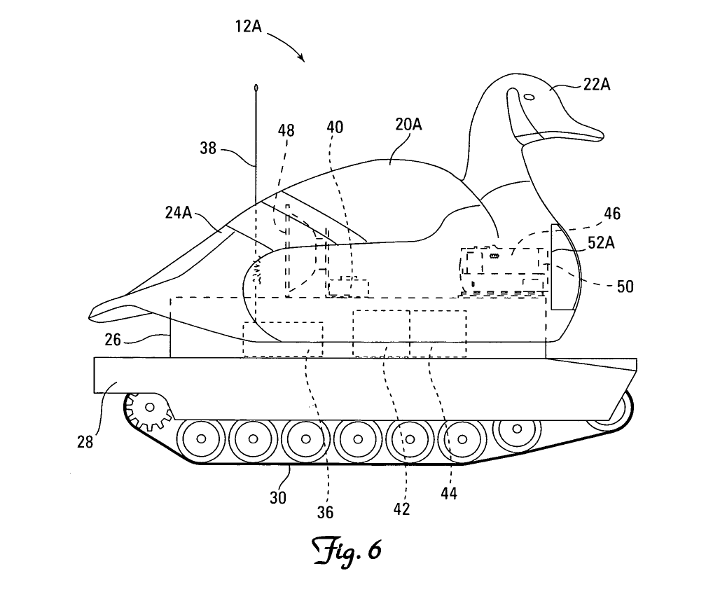

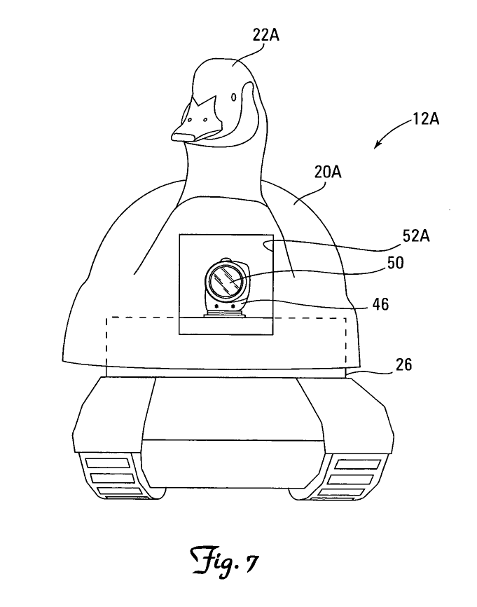

FIG. 6 is a side view and FIG. 7 is a front view of another embodiment of remote controlled decoy 12A resembling a duck. Depicted in FIGS. 6 & 7 are: duck decoy 12A, animal shell 20A, head portion 22A, tail portion 24A, base 26, chassis 28, and tracks 30. Also depicted are parts of duck decoy 12A located beneath animal shell 20A (shown in phantom lines): receiver 36, antenna 38, game caller 40, motor 42, battery 44, and video recorder 46. Game caller 40 includes speaker 48, video recorder 46 includes lens 50, and head portion 22A of animal shell 20A includes opening 52A. When operated, duck decoy 12A is capable of movement, sound, and recording images in the same ways as turkey decoy 12.

Many components of duck decoy 12A are similar to those of turkey decoy 12 described above. Base 26, chassis 28, tracks 30, receiver 36, antenna 38, game caller 40, motor 42, battery 44, video recorder, 46, speaker 48, and lens 50 of duck decoy 12A can be constructed similarly to like-named and numbered components of turkey decoy 12 described with respect to FIGS. 1-5. Principally distinguishing duck decoy 12A from turkey decoy 12 is animal shell 20A. Instead of resembling a turkey, animal shell 20A resembles a duck. Also, game caller 40 produces audio appropriate to duck decoy 12A, such as “quacking”.

Head portion 22A carries a head of a duck and tail portion 24A carries a tail of a duck. As was the case for turkey decoy 12, tail portion 24A of duck decoy 12A is located above and surrounding a rear facing game caller 40 including speaker 48. Likewise, head portion 22A of duck decoy 12A is located above and surrounding a forward facing video recorder 46 including lens 50. Opening 52A in head portion 22A provides an unobstructed forward view for lens 50 of video recorder 46 to capture images. In duck decoy 12A, opening 52A is positioned lower on head portion 22A than was the case for turkey decoy 12, rendering stand 35 unnecessary. A bottom surface of video camera 46 is mounted to a top surface of base 26, which is aligned slightly above a bottom edge of opening 52A. Lens 50 is centered within opening 52A to record images occurring in front of duck decoy 12A. As described above, the functions of game caller 40, motor 42/tracks 30, and video recorder 46 are remotely operated via actuators 34 of remote control 14. A hunter can impart life-like movement and sounds to duck decoy 12A to attract wild game while recording hunting images from duck decoy 12A.

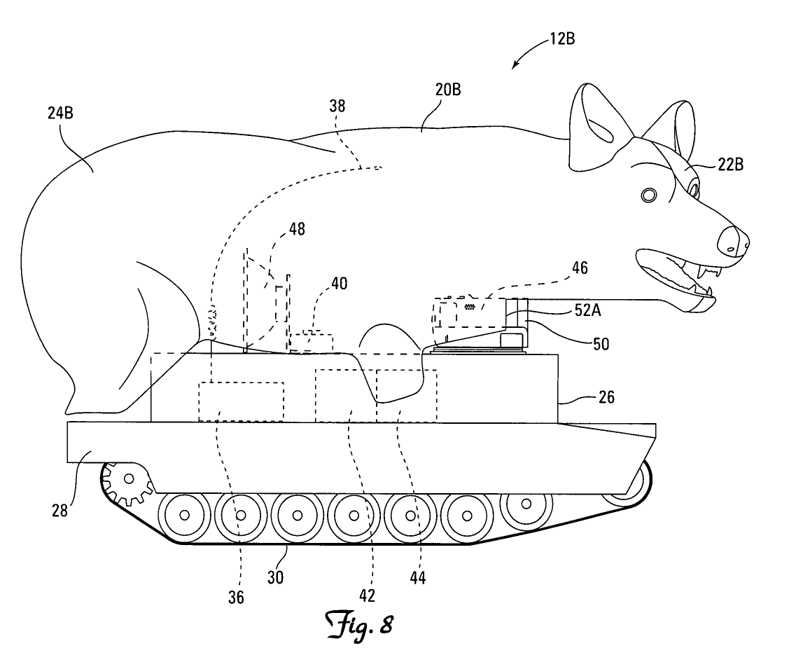

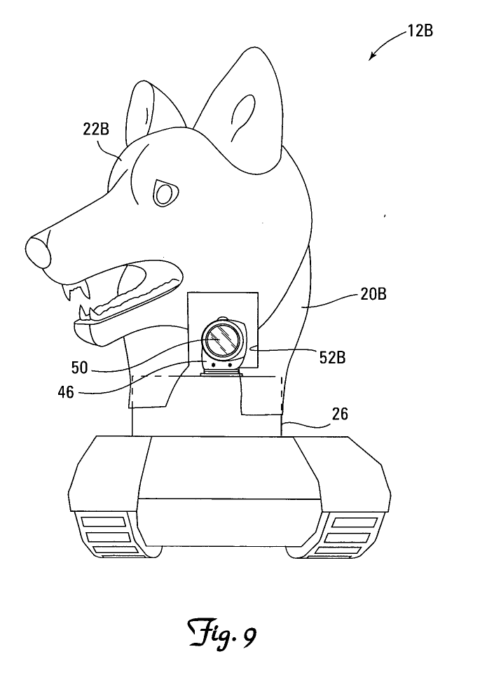

FIG. 8 is a side view and FIG. 9 is a front view of another embodiment of remote controlled decoy 12B resembling a cyote. Depicted in FIGS. 8 & 9 are: cyote decoy 12B, animal shell 20B, head portion 22B, tail portion 24B, base 26, chassis 28, and tracks 30. Also depicted are parts of cyote decoy 12B located beneath animal shell 20B (shown in phantom lines): receiver 36, antenna 38, game caller 40, motor 42, battery 44, and video recorder 46. Game caller 40 includes speaker 48, video recorder 46 includes lens 50, and head portion 22B of animal shell 20B includes opening 52B. When operated, cyote decoy 12B is capable of movement, sound, and recording images in the same ways as turkey decoy 12 and duck decoy 12A.

Many components of cyote decoy 12B are similar to those of turkey decoy 12 and duck decoy 12A described above. Base 26, chassis 28, tracks 30, receiver 36, antenna 38, game caller 40, motor 42, battery 44, video recorder, 46, speaker 48, and lens 50 of cyote decoy 12B can be constructed similarly to like-named and numbered components of turkey decoy 12 described with respect to FIGS. 1-5 and duck decoy 12A described with respect to FIGS. 6-7. Principally distinguishing cyote decoy 12B from turkey decoy 12 and duck decoy 12A is animal shell 20B. Instead of resembling a turkey or duck, animal shell 20B resembles a cyote. Also, game caller 40 produces audio appropriate to cyote decoy 12B, such as “howling” or “barking”.

Head portion 22B carries a head of a cyote and tail portion 24B carries a rear quarters and tail of a cyote. As was the case for turkey decoy 12 and duck decoy 12A, tail portion 24B of cyote decoy 12B is located above and surrounding a rear facing game caller 40 including speaker 48. Likewise, head portion 22B of cyote decoy 12B is located above and surrounding a forward facing video recorder 46 including lens 50. Opening 52B in head portion 22B provides an unobstructed forward view for lens 50 of video recorder 46 to capture images. In cyote decoy 12B, opening 52B is positioned low on head portion 22B like in duck decoy 12A, rendering stand 35 unnecessary. A bottom surface of video camera 46 is mounted to a top surface of base 26, which is aligned with a bottom edge of opening 52B. Lens 50 is centered within opening 52B to record images occurring in front of cyote decoy 12B. As described above, the functions of game caller 40, motor 42/tracks 30, and video recorder 46 are remotely operated via actuators 34 of remote control 14. A hunter can impart life-like movement and sounds to cyote decoy 12B to attract wild game while recording hunting images from cyote decoy 12B.

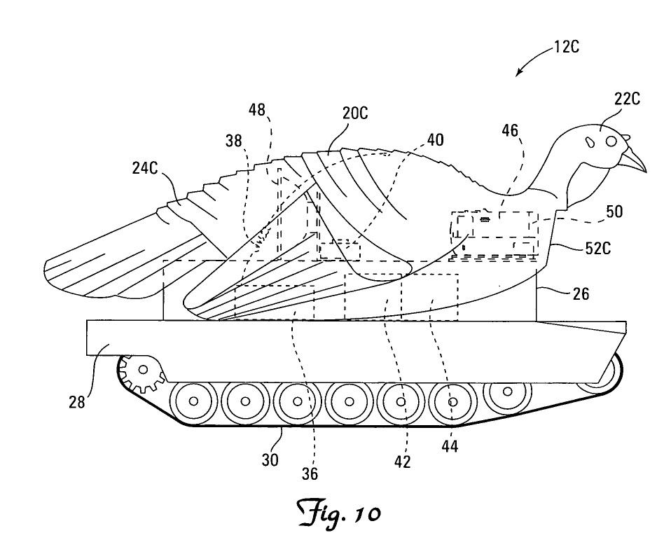

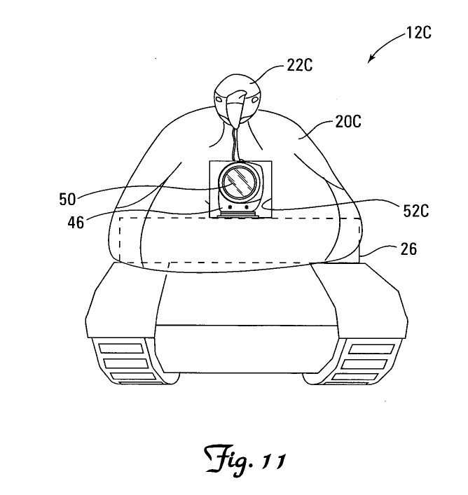

FIG. 10 is a side view and FIG. 11 is a front view of another embodiment of remote controlled decoy 12C resembling a female turkey or hen. Depicted in FIGS. 10 & 11 are: hen decoy 12C, animal shell 20C, head portion 22C, tail portion 24C, base, chassis 28, and tracks 30. Also depicted are parts of hen decoy 12C located beneath animal shell 20C (shown in phantom lines): base 26, receiver 36, antenna 38, game caller 40, motor 42, battery 44, and video recorder 46. Game caller 40 includes speaker 48, video recorder 46 includes lens 50, and head portion 22C of animal shell 20C includes opening 52C. When operated, hen decoy 12C is capable of movement, sound, and recording images in the same ways as turkey decoy 12, duck decoy 12A, and cyote decoy 12B.

Many components of hen decoy 12C are similar to those of turkey decoy 12, duck decoy 12A, and cyote decoy 12B described above. Base 26, chassis 28, tracks 30, receiver 36, antenna 38, game caller 40, motor 42, battery 44, video recorder, 46, speaker 48, and lens 50 of hen decoy 12C can be constructed similarly to like-named and numbered components of turkey decoy 12 described with respect to FIGS. 1-5, duck decoy 12A described with respect to FIGS. 6-7, and cyote decoy 12B described with respect to FIGS. 8-9. Principally distinguishing hen decoy 12C from turkey decoy 12, duck decoy 12A, and cyote decoy 12B is animal shell 20C. Instead of resembling a male turkey, a duck, or a cyote, animal shell 20C resembles a female turkey or hen. Also, game caller 40 produces audio appropriate to hen decoy 12C, such as “clucking” or “clicking”.

Head portion 22C carries a head of a hen and tail portion 24C carries a tail of a hen. As was the case for turkey decoy 12, duck decoy 12A, and cyote decoy 12B, tail portion 24C of hen decoy 12C is located above and surrounding a rear facing game caller 40 including speaker 48. Likewise, head portion 22C of hen decoy 12C is located above and surrounding a forward facing video recorder 46 including lens 50. Opening 52C in head portion 22C provides an unobstructed forward view for video recorder 46 to capture images. In hen decoy 12C, opening 52C is positioned low on head portion 22C like in duck decoy 12A and cyote decoy 12B rendering stand 35 unnecessary. A bottom surface of video camera 46 is mounted to a top surface of base 26, which is aligned with a bottom edge of opening 52C. Lens 50 is centered within opening 52C to record images occurring in front of hen decoy 12C. As described above, the functions of game caller 40, motor 42/tracks 30, and video recorder 46 are remotely operated via actuators 34 of remote control 14. A hunter can impart life like movement and sounds to hen decoy 12C to attract wild game while recording hunting images from hen decoy 12C.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A remote controlled decoy comprising:
a ground engaging element;
a chassis attached to the ground engaging element;
a motor for driving the ground engaging element, the motor attached to the chassis;
a video recorder for recording images, the video recorder mounted above the chassis;
a game caller for producing audio, the game caller mounted above the chassis; and
an animal shell removably attachable around the video recorder and the game caller.

2. The decoy of claim 1, wherein the ground engaging element comprises two continuous tracks.

3. The decoy of claim 1, wherein the animal shell obscures the video recorder and game caller from sight.

4. The decoy of claim 1, wherein the animal shell protects the video recorder and game caller from weather.

5. The decoy of claim 1, wherein the video recorder has a lens pointed in a first, forward direction and the game caller has a speaker pointed in a second, rearward direction.

6. The decoy of claim 5, wherein the animal shell has a head portion and a tail portion, the head portion surrounding the video recorder and the tail portion surrounding the game caller.

7. The decoy of claim 6, wherein the head portion includes an opening to provide an unobstructed view for the lens.

8. The decoy of claim 7, wherein the animal shell comprises a male turkey skin.

9. The decoy of claim 7, wherein the animal shell comprises a duck skin.

10. The decoy of claim 7, wherein the animal shell comprises a cyote skin.

11. The decoy of claim 7, wherein the animal shell comprises a female turkey skin.

12. The decoy of claim 1, further comprising:
a remote control for transmitting signals to a receiver, the receiver being attached to the chassis.

13. The decoy of claim 12, wherein the remote control includes actuators for remotely controlling functions of the motor, the video recorder, and the game caller.

14. The decoy of claim 13, wherein the remote control includes a strap for fastening the remote to an operator.

15. A remote controlled decoy comprising:
an animal shell having an opening therein; and
a video recorder located within the animal shell, the video camera having a lens positioned with respect to the opening for unobstructed recording of images.

16. The decoy of claim 15, further comprising:
a game caller located within the animal shell, the game caller having a speaker for producing audio.

17. The decoy of claim 15, further comprising:
a ground engaging element located beneath the animal shell; and
a motor attached to the ground engaging element.

18. The decoy of claim 1, further comprising:
a receiver adjacent the motor, the receiver for receiving signals transmitted by a remote control.

19. A method for attracting game utilizing a remote controlled decoy, the method comprising the steps of:
actuating ground engaging elements on the decoy via the remote control, such that the decoy moves with respect to the ground; and
actuating a video recorder on the decoy via the remote control, such that the decoy records images.

20. The method of claim 19, further comprising:
actuating a game caller on the decoy via the remote control, such that the decoy produces audio.
